(19) United States
(12) Patent Application Publication
(10) Pub. No.: US 2002/0051325 A1
(43) Pub. Date: May 2, 2002

(54) Magnetic head assembly

(75) Inventor: Makoto Miyazaki, Gunma (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 09/975,018

(22) Filed: Oct. 12, 2001

(30) Foreign Application Priority Data
Oct. 30, 2000 (JP) 2000-330419

(51) Int. Cl. G11B 5/54

(52) U.S. Cl. 360/255.6

(57) ABSTRACT

A magnetic head assembly has a first magnetic head and a second magnetic head, which approach or move away from a front and a rear surface, respectively, of a magnetic disk in order to record onto or read from the magnetic disk, and a carriage and holder supporting the first and second magnetic heads, respectively. The holder has a mating protrusion, which is pushed upward by a pressure plate of a magnetic disk from a loaded position in which the disk is inserted to an unloaded position in which the disk is not inserted, and is supported at a position swung in relation to the carriage. The holder has a swinging restriction part, which restricts the swinging within an aperture of the pressure plate about the mating protrusion as a pivot point.

### BACKGROUND OF THE INVENTION

1. Field of the Invention

The present invention relates to a magnetic head assembly for a magnetic disk apparatus, and more particularly to a magnetic head assembly having a structure that avoids a problem with collision of a holder-side magnetic head with a carriage-side magnetic head when unexpected strong shock is applied to the assembly during when the holder is supported in the unloading position.

2. Related Art

FIG. 12 of the accompanying drawings is an oblique view showing the overall configuration of a magnetic head assembly of the past. This magnetic head assembly 23 is assembled into a magnetic disk apparatus (not shown in the drawing), and has a first and a second magnetic 7 and 5 position at the front side and rear side, respectively, of a magnetic disk, a carriage 9, which supports the first magnetic head 7, and a holder 14, which supports the second magnetic head 5, and swings so as to bring the second magnetic head 5 closer to or farther away from the first magnetic head 7. The holder 14 is supported by the carriage side via a hinge 6 having a spring force, and is urged so as to swing in the direction of the carriage 9 by a torsion spring 10.

In the above-noted magnetic head assembly 23, with the magnetic head assembly mounted in the magnetic disk apparatus, when the second magnetic head, supported by the holder 14, moves in the sliding direction indicated by the arrow 16 along the aperture 18 formed in the pressure plate 8 of the magnetic disk apparatus (radial direction with respect to the magnetic disk), the second magnetic head 5 and the first magnetic head 7 in opposition thereto perform recording onto and playback from the magnetic disk.

FIG. 13 is a side view showing the unload condition of the magnetic head assembly. With the magnetic head assembly 23 in this condition, the pressure plate 8, which rises with the operation of the drive mechanism of the magnetic disk apparatus (not shown in the drawing) pushes up the rear surface 19 of a mating protrusion 12 of the holder 14 at the edge part of the aperture 18 (refer to FIG. 12). By this action, the holder 14 swings about the hinge 6 as a pivot in the clockwise direction as shown in FIG. 13, so that the pressure plate 8 supports this swung condition.

With the magnetic head assembly 23 in the unload condition, if the magnetic disk apparatus 20 is mistakenly dropped so as to subject the magnetic head assembly 23 to a strong shock, as shown in FIG. 14, the holder 14 momentarily swings in the direction of the arrow F within the aperture 18, about the rear surface 19 of the mating protrusion 12 making contact with the edge part of the aperture 18 (FIG. 12) of the pressure plate 8 as a center of the swing.

If the acceleration of the above-noted shock is large, the amount of swing of the holder 14 will be large, so that the second magnetic head 5 might collide heavily with the first magnetic head 7, and in an extreme case there could be damage to the first and second magnetic heads 7 and 5. In particular in a case in which the personal computer into which the magnetic disk apparatus 20 is mounted is a laptop type or note-book computer, compared to the case of a desktop personal computer, the computer is more frequently carried about, leading to a higher probability of dropping, thereby resulting in a greater need for immunity to shock.

Accordingly, it is an object of the present invention, in consideration of the above-noted problems, to provide a magnetic head assembly having good immunity to shock, and reliably preventing problems such as damage occurring when a large shock applied thereto when in the unload condition, caused by the first magnetic head colliding with the second magnetic head.

### SUMMARY OF THE INVENTION

To achieve the above-noted object, the present invention adopts the following basic technical constitution.

Specifically, a magnetic head assembly according to the present invention is a magnetic head assembly for a magnetic disk apparatus, this magnetic head assembly having a first and a second magnetic head, which come into contact with or come into proximity to the front and rear surfaces, respectively, of a magnetic disk inserted into the magnetic disk apparatus so as to perform recording to and playback from the magnetic disk, and a carriage and holder which support the first and second magnetic heads, respectively, wherein the holder has a mating protrusion formed on an edge part thereof, this mating protrusion pushing up a pressure member of the magnetic disk apparatus from the load position at which the magnetic disk is inserted to the unload position at which the disk is not inserted, the magnetic head assembly being supported at a position swung with respect to the carriage.

In this magnetic head assembly, the holder has a swinging restriction part that restricts the swinging thereof within an aperture of the pressure member with a mating protrusion which serving as a swinging pivot point.

In a magnetic head assembly according to the present invention, when a shock is applied to the assembly in the unloaded condition, the swinging restriction part restricts the momentary swinging operation of the holder within the aperture about the mating protrusion contacting with the pressure member as a pivot center.

For this reason, it is possible to prevent damage or other problems occurring as a result of a collision between the first and second magnetic heads, thereby achieving high immunity to shock.

In a magnetic head assembly according to the present invention, the above-noted swinging restriction part is formed as one integrally with the mating protrusion. In this case, it is possible to fabricate the swinging restriction part simultaneously with the formation of the mating protrusion, thereby simplifying the manufacturing process. The mating protrusion formed as one integrally with the swinging restriction part preferably has a sliding direction length set, for example, within the range from 4 to 8 mm. In contrast to this, in a magnetic head assembly of the past, the sliding direction length of the mating protrusion (width) was set, for example, to 1 to 3 mm.

More specifically, the swinging restriction part is formed on a part of the mating protrusion, and has an arc shape that makes line contact with the pressure member, a spherical shape that makes point contact with the pressure member, or a flat shape that makes surface contact with the pressure member. In this case, it is possible to obtain a swinging restriction part extremely simply. In particular in the case in which the shape is such as to achieve either a linear or point contact, there is the effect of reducing the friction with the swinging restriction part when the holder slides along the aperture formed in a pressure plate, for example, thereby enhancing the smoothness of operation.

Alternately, rather than the above, there is an aspect of the present invention in which it is preferable that the swinging restriction part be made separately from the mating protrusion, and the separate protrusion being formed on an edge part of the holder. In this case, compared to the case in which the swinging restriction part is formed as one integrally with the mating protrusion, the swinging restriction part can be made to make contact with the pressure plate at a point that is at a distance from the mating protrusion serving as the swinging pivot point when a shock occurs, making it possible to achieve a better effect of restricting the swinging of the holder.

### BRIEF DESCRIPTION OF THE DRAWINGS

FIG. 1 is an oblique view showing the overall configuration of a magnetic disc apparatus into which a magnetic head assembly according to a first embodiment of the present invention is built.

FIG. 2 is an oblique view showing the condition of the magnetic disk apparatus shown in FIG. 1 before assembly.

FIG. 3 is an oblique view showing the magnetic head assembly of the first embodiment in the unloaded condition.

FIG. 4 is an oblique view showing the magnetic head assembly of the first embodiment in the loaded condition.

FIG. 5 is an oblique view showing just the holder of the first embodiment.

FIG. 6 is a side elevation showing the holder of FIG. 5.

FIG. 7 is a side elevation showing the magnetic head assembly of the first embodiment in the unloaded condition.

FIG. 8 is a side elevation showing the magnetic head assembly of FIG. 7 in the loaded condition.

FIG. 9 is a side elevation showing the magnetic head assembly of FIG. 7 when a shock is being applied thereto.

FIG. 10 is an oblique view showing a holder of a second embodiment of the present invention.

FIG. 11 is a side elevation showing a holder of a third embodiment of the present invention.

FIG. 12 is an oblique view showing the configuration of a magnetic head assembly of the past.

FIG. 13 is a side elevation showing the magnetic head of the past in the unloaded condition.

FIG. 14 is a side elevation showing the magnetic head assembly shown in FIG. 13 when being subjected to a shock.

### DETAILED DESCRIPTION OF THE PREFERRED EMBODIMENTS

Embodiments of the present invention are described in detail below, with references made to relevant accompanying drawings.

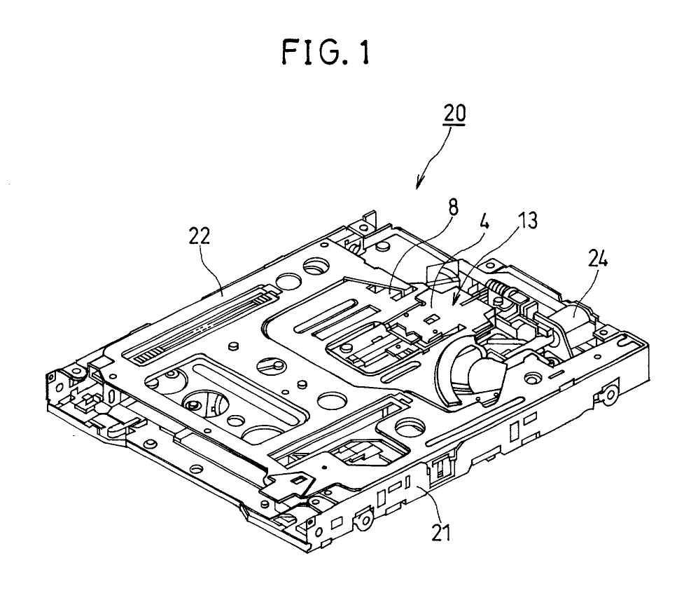

Specifically, FIG. 1 is an oblique view showing the overall configuration of a magnetic disk apparatus into which a magnetic head assembly according to an embodiment of the present invention is assembled. In this embodiment, the magnetic disk apparatus 20 has a base 21, an insertion table 22 and pressure plate 8 built into the base 21 and mutually assembled to one another, a drive mechanism 24, which raises or lowers the pressure plate 8 with respect to the base 21 and the insertion table 22, and a magnetic head assembly 13.

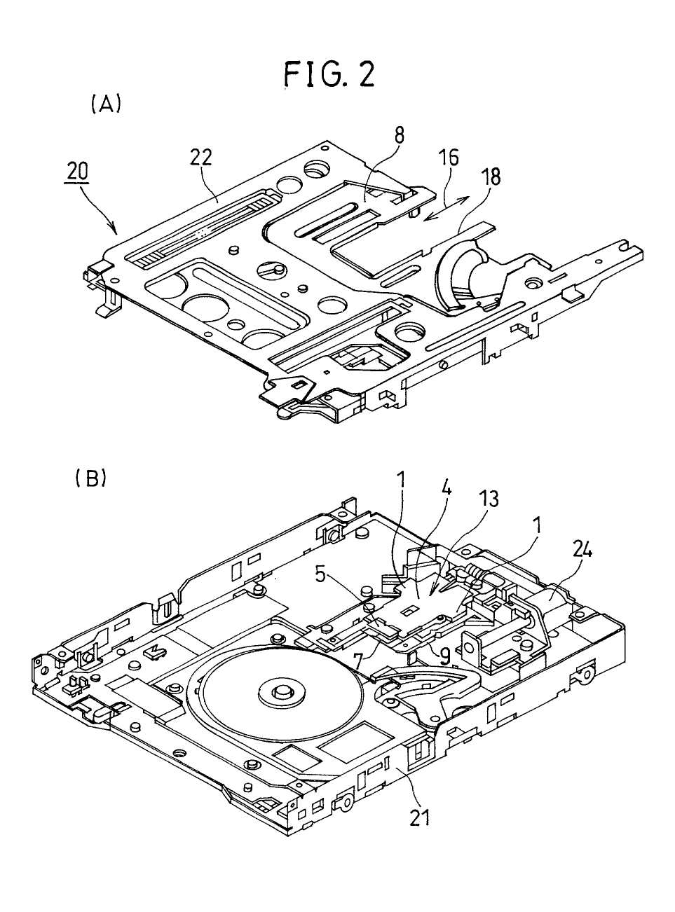

FIG. 2 is an oblique view showing the magnetic disk apparatus of FIG. 1 in the condition before assembly. The pressure plate 8 has an aperture 18 that is long in a direction of sliding of the magnetic head assembly 13 indicated by the arrow 16. The magnetic head assembly 13 has first and second magnetic heads 7 and 5 in mutual opposition to one another, and a carriage 9 and holder 4, which support the first and second magnetic heads 7 and 5, respectively.

The holder 4 has a pair of mating protrusions 1 protruding from an end part thereof in a direction perpendicular to the sliding direction (16), and in the condition in which the pressure plate 8 is assembled to the base 21, it is housed so as to freely slide within the aperture 18, the edge part of the aperture 18 being positioned at the lower side of the pair of mating protrusions 1. By adopting this arrangement, when the pressure plate 8 is raised by the drive mechanism 24, the holder 4 is supported by the pressure plate 8 via the pair of mating protrusions 1 from below, and it is caused to swing with respect to the carriage 9.

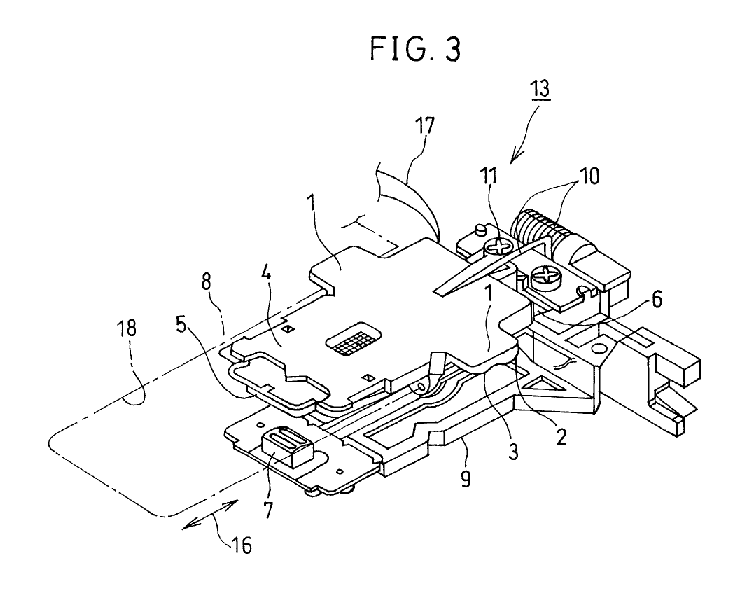

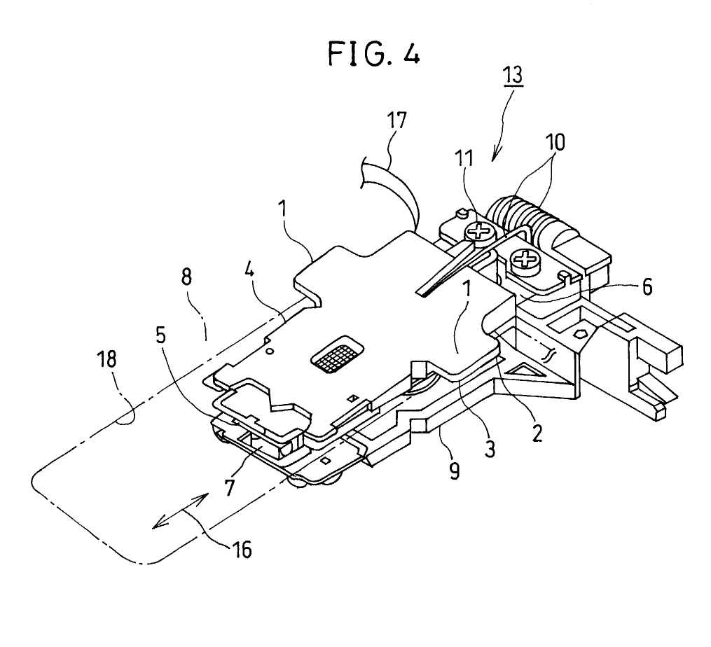

FIG. 3 is an oblique view showing the magnetic head assembly in the unloaded condition, and FIG. 4 is an oblique view showing the magnetic head in the loaded condition. The magnetic head assembly 13 has first and second magnetic heads 7 and 5, which are in contact with or in proximity to the front and rear surfaces, respectively of an inserted magnetic disk so as to record onto and playback from the magnetic disk, a carriage 9 supporting the first magnetic head 7, and a holder 4 supporting the second magnetic head 5 and swinging so as to bring the second magnetic head 5 closer to or farther away from the first magnetic head 7. The first and second magnetic heads 7 and 5 are adhesively fixed to the carriage 9 and the holder 4, respectively.

The holder 4 is supported to the carriage 9 side via a hinge 6 fixed by a screw 11 to the carriage 9, and this is urged so as to swing toward the carriage 9 by a torsion spring 10. By doing this, when a magnetic disk is inserted into or ejected from the magnetic disk apparatus 20 (FIG. 1), the holder 4 has an appropriate load applied to it by the torsion spring 10, so that, driven by the drive force of the drive mechanism 24 (FIG. 1) it swings about the hinge 6 so as to either approach to or move away from the magnetic disk. The passing of signals between the magnetic heads 7 and 5 and a controller provided in the magnetic disk apparatus is performed via a flexible printed circuit 17 connected to the magnetic head assembly.

With the magnetic head assembly 13 mounted in the magnetic disk apparatus, the holder 4 supporting the second magnetic head 5 moves in the slide direction indicated by the arrow 16, along the aperture 18 of the pressure plate 8. The holder 4 has a pair of mating protrusions 1 protruding from an edge part in a direction perpendicular to the slide direction (16), and when the magnetic head assembly 13 is assembled into the base 21 (FIG. 1), with the lower side part of the mating protrusion 1 positioned at the edge part of the aperture 18, the holder is held so that it can freely slide within the aperture 18.

By adopting the above-noted structure, when the pressure plate 8 rises from the loaded position in which the second magnetic head 5 is in proximity to the first magnetic head 7, the edge part of the aperture 18 pushes up a back surface of the mating protrusion 1.

On a back surface of the mating protrusion 1 a part that makes contact with the edge part of the aperture 18 (rotating pivot point 2) and a part of a swinging restriction part 3 that restricts the swinging when a shock occurs are.

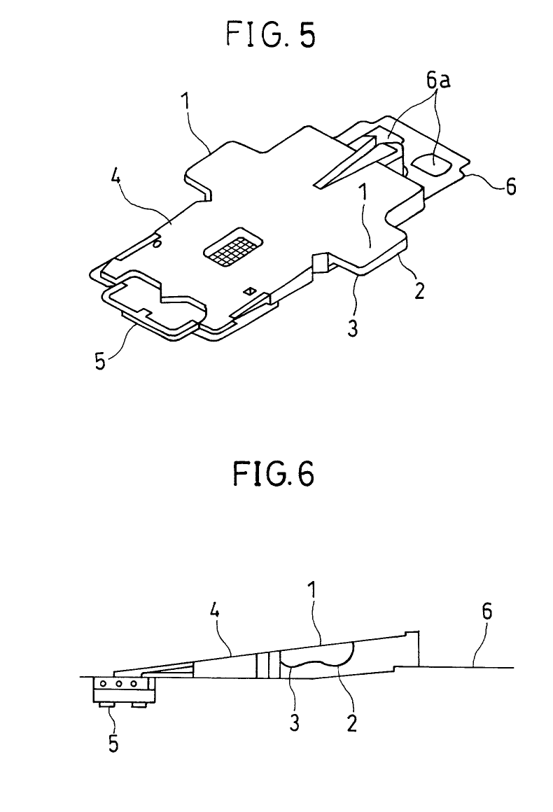

FIG. 5 is an oblique view showing the holder alone. The holder 4 has a hinge 6 attached to it so as to protrude toward the rear, this hinge 6 having a screw hole 6a formed in it, into which the screw 11 is inserted.

FIG. 6 is an oblique view showing the holder of FIG. 5 seen from the front. At the mating protrusion 1, a swinging pivot point 2 is provided on the rear surface thereof (hinge 6 side), this being an arc or hemispherical shape protruding downward, and the swinging restriction part 3 is provided at the front part of the rear surface forming an arc or hemispherical shape that is smaller than the swinging pivot point.

When the magnetic disk is mounted in loaded condition and the holder 4 slides, the swinging pivot point 2 and swinging restriction part 3 make a line or point contact with the edge part of the aperture 18, so that there is a reduction in the frictional force between the edge part and the swinging pivot point 2 and the swinging restriction part 3.

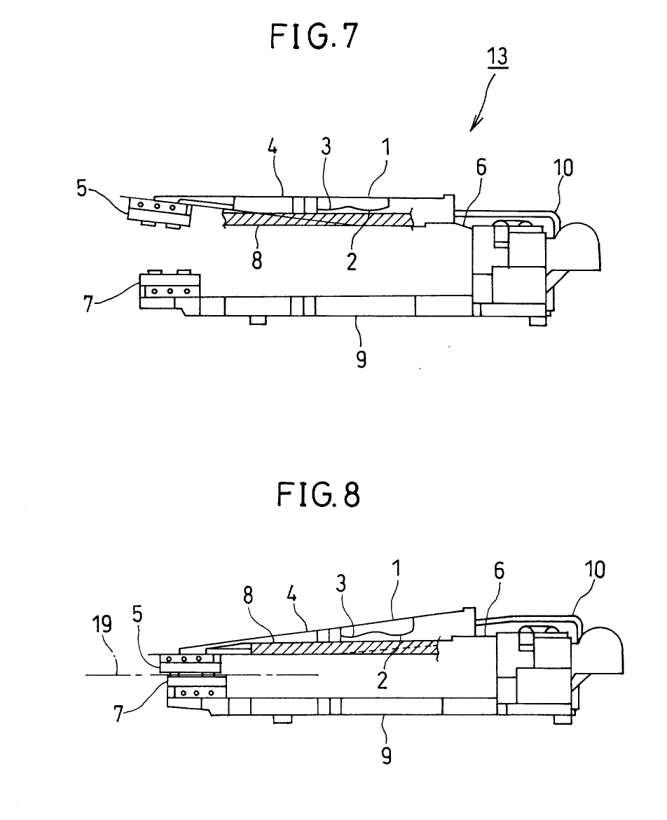

The operation of the above-described magnetic head assembly is as follows. FIG. 7 is a side elevation showing the magnetic head assembly in the unloaded condition, in which a magnetic disk is not inserted, the edge part of the aperture 18 of the pressure plate 8 pushing up the rear surface (swinging pivot point 2) of the mating protrusion 1, and the holder 4 swinging clockwise (as shown in FIG. 7) about the base end of the carriage 9 of the hinge 6 as a swinging pivot point and supported same as its current condition.

FIG. 8 is a side elevation showing the magnetic disk in the loaded condition. When the magnetic disk 19 is inserted, a detection means (not shown in the drawing) installed in the magnetic disk apparatus 20 (FIG. 1) detects the insertion of the magnetic disk and based on this detection the drive mechanism 24 (FIG. 1) lowers the pressure plate 8. By doing this, the holder 4, following the urging of the torsion spring 10, swings in the counterclockwise direction of FIG. 8 about the hinge 6 as a center of swinging.

For this reason, the second magnetic head 5 gently approaches the first magnetic head 7, and the first and second magnetic heads 7 and 5 perform recording to or playback in contact with or in proximity to the front and rear surfaces, respectively, of the magnetic disk 19. In the loaded condition, the swinging pivot point 2 and the swinging restriction part 3 establishes a slight gap between it and the edge part of the aperture 18 of the pressure plate 8.

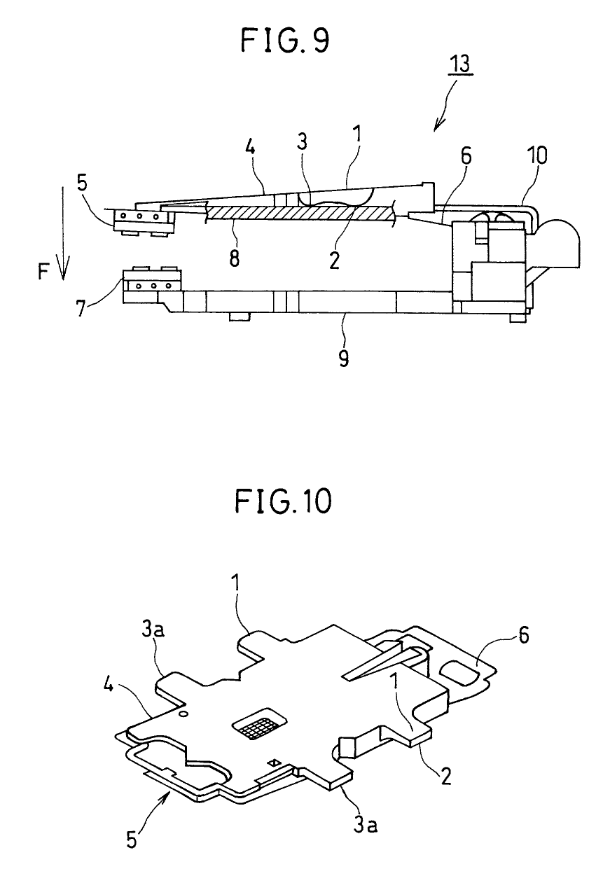

In the unloaded condition shown in FIG. 7, if the magnetic disk apparatus into which the magnetic head assembly 13 is installed is dropped, inertia governed by the weight of the second magnetic head 5 causes the a force to be applied in the direction indicated by the arrow F in FIG. 9, so that the holder 4 is about to momentarily swing in the counterclockwise direction (in FIG. 7) within the aperture 18 of the pressure plate 8 about the mating protrusion 1 that is in contact with the edge part of the aperture 18 of the pressure plate 8 as a center of pivot.

However, because the swinging restriction part 3 positioned at the second magnetic head 5 side with respect to the swinging pivot point 2 is mated with the edge part, the swinging of the holder 4 is restricted, so that the second magnetic head 5 does not impart a shock to the first magnetic head 7.

In an embodiment as described above, because the mating protrusion 1 is wider than in the past, and has the swinging restriction part 3 formed on the rear surface thereof, it is possible to achieve high shock immunity without the need for additional members to improve the shock immunity.

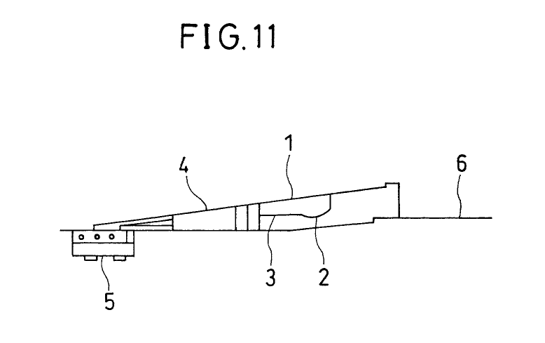

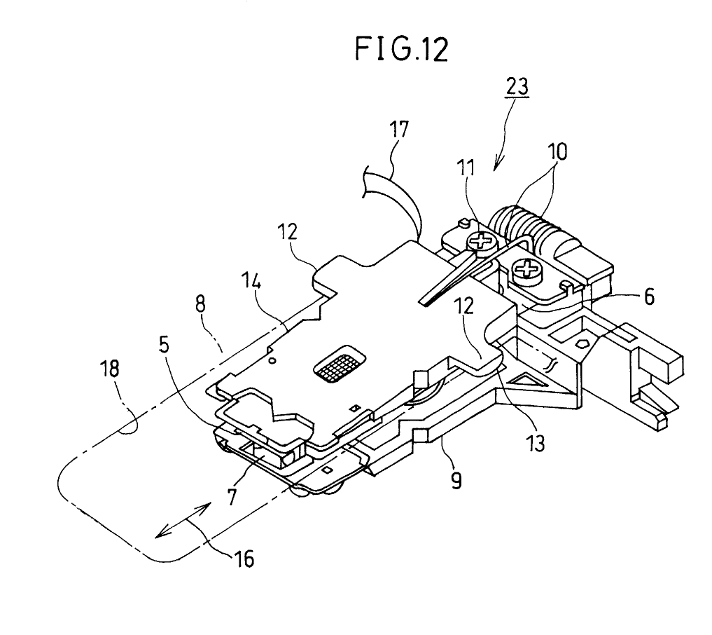

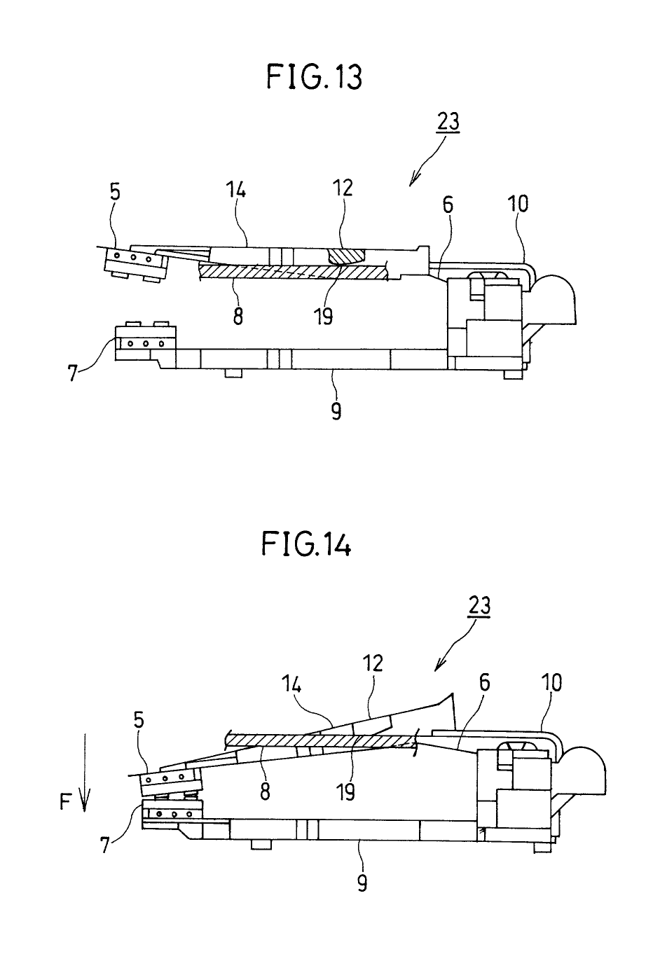

A second embodiment of the present invention is shown in the oblique view of FIG. 10. In contrast to the first embodiment, in which the swinging restriction part 3 and swinging pivot point 2 are formed on the rear surface of the mating protrusion, in the second embodiment an arm-shaped swinging restriction part is formed separately from the mating protrusion 1. That is, on the second magnetic head 5 side of the mating protrusion 1 having a swinging pivot point 2 on the lower surface is formed a swinging restriction arm 3a, which protrudes from the edge part of the mating protrusion 1 at a prescribed removed position.

In an embodiment such as this, compared to the first embodiment, in which the swinging restriction part 3 is formed as one with the mating protrusion 1, because a swinging restriction arm 3a at a position removed by the second magnetic head 5 from the mating protrusion 1 serving as a swinging pivot point when a shock occurs, there is a further improvement in the effect of restricting the swinging of the holder 4 in the unloaded condition.

FIG. 11 is a side elevation showing a third embodiment of the present invention. In contrast to the first and second embodiments, in which the swinging restriction part 3 was an arc shape or a hemispherical shape, in the third embodiment a swinging restriction part 3 having a flat (edge) shape is formed on the second magnetic head 5 side of the swinging pivot point 2 formed on the rear side of the mating protrusion 1. In this embodiment as well, by bringing the edge-shaped swinging restriction part 3 up against the edge part of the aperture 18 of the pressure plate 8, it is possible to achieve an effect similar to that of the first embodiment.

Although the foregoing first to third embodiments are described for the case in which a swinging restriction part 3 or swinging restriction arm 3a is formed on both of a pair of mating protrusions 1, it will be understood that this is not be interpreted as a restriction, it being alternately possible to make a variety of modifications and changes to the above-described embodiments to achieve a magnetic head assembly that is within the scope of the claimed present invention.

As described in detail above, according to a magnetic head assembly of the present invention, it is possible to achieve a high immunity to shock, by preventing problems such as damage such as might occur when a strong shock results in the second magnetic head colliding with the first magnetic head.

What is claimed is:

1. A magnetic head assembly for a magnetic disk apparatus, comprising:
a first magnetic head and a second magnetic head, which come into contact with or come into proximity to front and rear surfaces, respectively, of a magnetic disk inserted into said magnetic disk apparatus so as to perform recording to and playback from said magnetic disk; and
a carriage and holder which support said first and said second magnetic heads, respectively,
wherein said holder comprises a mating protrusion formed on an edge part thereof, said holder being pushed up from a loaded position at which said magnetic disk is inserted to an unloaded position at which the disk is not inserted, by said mating protrusion pushing up a pressure member of said magnetic disk apparatus and said magnetic head assembly being supported at a position swung with respect to said carriage, and further wherein, said holder having a swinging restriction part that restricts the swinging thereof with said mating protrusion as a swinging pivot point, within an aperture of the pressure member.

2. A magnetic head assembly according to claim 1, wherein said swinging restriction part is formed integrally with said mating protrusion.

3. A magnetic head assembly according to claim 2, wherein said swinging restriction part is formed on a part of said mating protrusion, and has an arc shape making a line contact, a hemispherical shape making a point contact, or a flat shape making a plane contact with said pressure member.

4. A magnetic head assembly according to claim 1, wherein said swinging restriction part is on an edge part of said holder, separate from said mating protrusion.
